(19) United States
(12) Patent Application Publication
(10) Pub. No.: US 2006/0053921 A1
(43) Pub. Date: Mar. 16, 2006

(54) Actuator apparatus

(75) Inventors: Yuji Kawamura, Kanagawa (JP); Makito Kawamoto, Kanagawa (JP); Toshimasa Wada, Kanagawa (JP); Ikuo Nakamura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Jidosha Denki Kogyo Co., Ltd., Yokohama-shi (JP)

(21) Appl. No.: 11/211,078

(22) Filed: Aug. 25, 2005

(30) Foreign Application Priority Data
Aug. 26, 2004 (JP) P.2004-246998
Aug. 26, 2004 (JP) P.2004-246999
Aug. 26, 2004 (JP) P.2004-247000

(51) Int. Cl. F16H 1/16

(52) U.S. Cl. 74/425

(57) ABSTRACT

In an actuator apparatus including a case having a cover for covering a motor containing portion and a gear containing portion, a motor contained in the motor containing portion, an output gear rotatably contained in the gear containing portion and driven to rotate by a drive shaft of the motor via a reduction gear, an output shaft rotatably supported by the case and rotated along with the output gear, and an output member attached to the output shaft, the motor is floatably supported in the motor containing portion via an elastic member, a front end of the drive shaft is rotatably supported via a bearing of a bearing holding portion of the gear containing portion, and the bearing is floatably supported by the bearing holding portion of the gear containing portion via a vibration isolating member.

### BACKGROUND OF THE INVENTION

The present application claims foreign priority based on Japanese Patent Application Nos. 2004-246998 filed on Aug. 26, 2004, 2004-246999 filed on Aug. 26, 2004 and 2004-247000 filed on Aug. 26, 2004, the contents of which are incorporated herein by reference in their entirety, and concurrently with the filing of this patent application.

The present invention relates to an actuator apparatus preferably used in, for example, a steering locking apparatus for locking or unlocking a steering shaft of a vehicle.

A steering locking apparatus of a background art is provided with a case having a cover for covering a motor containing portion and a gear containing portion, a motor contained in the motor containing portion of the case, an output gear rotatably contained in the gear containing portion of the case and driven to rotate by a drive shaft of the motor via a reduction gear, an output shaft fixed by being penetrated to a shaft portion of the output gear and rotated along with the output gear, an output cam attached to the output shaft and used in locking and unlocking a steering shaft, and a pair of limit switches arranged at the gear containing portion of the case and operated to be made ON or OFF by a cam portion integrally formed with the shaft portion of the output gear.

Further, an upper face of the output gear is projected with a projection brought into contact to be locked by a projection projected from an inner face of the cover. Further, when the projection of the output gear and the projection of the cover are brought into contact to be locked, a cam portion of the shaft portion of the output gear makes the limit switch ON to make electricity conduction of the motor OFF. In order to absorb a load when locking two projections of the projection of the output gear and the projection of the cover, the projection of the cover is attached with an elastic member.

There is known an actuator apparatus used in a steering locking apparatus of this kind shown by FIGS. 25 and 26 (refer to, for example, Patent Reference 1).

As shown by FIGS. 25 and 26, an actuator apparatus 1 is provided with a case 2 having a cover (not illustrated) for covering a motor containing portion 2a and a gear containing portion 2b, a motor 3 contained in the motor containing portion 2a of the case 2, an output gear 6 rotatably contained in the gear containing portion 2b of the case 2 and driven to rotate by a worm 4b of a drive shaft 4 of the motor 3 via a plurality of reduction gears 5A, 5B, 5C, an output shaft 7 penetrated to a center of the output gear 6 to fix and rotated along with the output gear 6, a sector gear used in locking and unlocking a steering shaft (both members are not illustrated) and the like.

As shown by FIG. 26, the motor 3 is fitted with O rings 8a, 8b made of rubber at respective forward and rearward bearing portions 4a, 3b thereof. The respective bearing portions 3a, 3b are brought into contact with side wall portions of the motor containing portion 2a via the respective O rings 8a, 8b and the motor 3 is held by the case 2. Further, a front end 4a of the drive shaft 4 of the motor 3 is rotatably supported via a leaf spring 9 as a bearing.

[Patent Reference 1] JP-A-9-215261

[Patent Reference 2] JP-A-2002-205622

[Patent Reference 3] JP-A-2002-326559

However, according to the actuator apparatus 1 of the background art, the motor 3 is only held in a state of being brought into contact with the side wall portions of the motor containing portion 2a of the case 2 via the O rings 8a, 8b made of rubber fitted to the respective bearing portions 3a, 3b, intervals between the motor 3 and the side wall portions of the motor containing portion 2a are not constituted by a floating support structure by an elastic member or the like and therefore, in rotating the reduction gear 5A, as shown by FIG. 26, a reaction force F from the reduction gear 5A is operated to the drive shaft 4, the drive shaft 4 of the motor 3 is bent in an arrow mark P direction by constituting a fulcrum by the bearing portion 3a, the motor 20 is easy to be rattled between the side wall portions of the motor containing portion 2a to incline (displace), and the reaction force F cannot sufficiently be absorbed only by elastic forces of the O rings 8a, 8b made of rubber. Further, by bending of bending the drive shaft 4 of the motor 3 or the like, a state of bringing the worm 4b of the drive shaft 4 of the motor 3 and the reduction gear 5A in mesh with each other is deteriorated and a failure in operation or noise (operating sound) is liable to be brought about and noise is liable to be transmitted to the case 2.

### SUMMARY OF THE INVENTION

Hence, the invention is carried out in order to resolve the above-described problem and it is an object thereof to provide an actuator apparatus capable of firmly restraining bending of a drive shaft of a motor or displacement of the motor by a reaction force from a reduction gear within predetermined ranges, firmly preventing a failure in operation by the bending of the drive shaft of the motor or the displacement of the motor or noise or the like from being brought about and capable of firmly preventing noise from being transmitted to a case.

According to Aspect 1 of the invention, there is provided an actuator apparatus including: a case having a cover for covering a motor containing portion and a gear containing portion, a motor contained in the motor containing portion of the case, an output gear rotatably contained in the gear containing portion of the case and driven to rotate by a drive shaft of the motor via a reduction gear, an output shaft rotatably supported by the case and rotated along with the output gear, and an output member attached to the output shaft, wherein the motor is floatably supported in the motor containing portion via an elastic member, a front end of the drive shaft of the motor is rotatably supported via a bearing held by a bearing holding portion of the gear containing portion, and the bearing is floatably supported by the bearing holding portion of the gear containing portion via a vibration isolating member.

According to Aspect 2 of the invention, there is provided the actuator apparatus described in Aspect 1, wherein the vibration isolating member is formed by an O ring made of rubber fitted to a small diameter portion of the bearing.

According to Aspect 3 of the invention, there is provided an actuator apparatus including: a case having a cover for covering a motor containing portion and a gear containing portion, a motor contained in the motor containing portion of the case, an output gear rotatably contained in the gear containing portion of the case and driven to rotate by a drive shaft of the motor via a reduction gear, an output shaft rotatably supported by the case and rotated along with the output gear, and an output member attached to the output shaft, wherein a projected portion is formed at at least a side wall of the motor containing portion, and the motor is floatably supported in the motor containing portion via an elastic member.

According to Aspect 4 of the invention, there is provided the actuator apparatus described in Aspect 3, wherein the projected portions are respectively formed at vicinities of respective corner portions of the two side walls of the motor containing portion opposed to each other.

According to Aspect 5 of the invention, there is provided an actuator apparatus including: a case having a cover for covering a motor containing portion and a gear containing portion, a motor contained in the motor containing portion of the case, an output gear rotatably contained in the gear containing portion of the case and driven to rotate by a drive shaft of the motor via a reduction gear, an output shaft rotatably supported by the case and rotated along with the output gear, and an output member attached to the output shaft, wherein projected portions are respectively formed at two side walls and a bottom wall of the motor containing portion, and the motor surrounded by an elastic member in a cylindrical shape is floatably supported between the projected portions in the motor containing portion.

According to Aspect 6 of the invention, there is provided the actuator apparatus described in Aspect 5, wherein at least a pair of the projected portions extended in parallel with the bottom wall of the motor containing portion are respectively formed and at least a pair of projected portions extended in parallel to intersect with at least the pair of projected portions are respectively formed at a bottom portion of the elastic member in the cylindrical shape.

According to Aspect 7 of the invention, there is provided the actuator apparatus described in Aspect 5, further including: harness pinching portions respectively formed at two side portions of the elastic member in the cylindrical shape.

According to Aspect 8 of the invention, there is provided the actuator apparatus described in Aspect 5, further including: a terminal holding portion formed at an upper portion of the elastic member in the cylindrical shape.

According to Aspect 9 of the invention, there is provided the actuator apparatus described in Aspect 5, wherein the elastic member in the cylindrical shape is formed by a thermoplastic elastomer species resin material.

As explained above, according to the invention of Aspect 1, by floatably supporting the motor in the motor containing portion via the elastic member, rotatably supporting the front end of the drive shaft of the motor via the bearing held by the bearing holding portion of the gear containing portion and floatably supporting the bearing by the bearing holding portion of the gear containing portion via the vibration isolating member, bending (deformation) of the drive shaft of the motor and displacement of the motor by a reaction from the reduction gear via the elastic member and the vibration isolating member can firmly be restrained within predetermined ranges, a failure in operation and noise or the like by bending of the drive shaft of the motor and displacement of the motor can firmly be prevented from being brought about and noise can firmly be prevented from being transmitted to the case.

According to the invention of Aspect 2, by forming the vibration isolating member by the O ring made of rubber fitted to the small diameter portion of the bearing, in bending the drive shaft of the motor by the reaction force from the reduction gear, deformation of the drive shaft can firmly be absorbed by the O ring made of rubber. Further, when the drive shaft is bent to some degree, a large diameter portion of the bearing is brought into contact with the bearing holding portion of the gear containing portion and bending of the drive shaft more than necessary can firmly be prevented.

According to the invention of Aspect 3, by forming the projected portion at at least the side wall of the motor containing portion and floatably supporting the motor in the motor containing portion via the elastic member, bending (deformation) of the drive shaft of the motor and displacement of the motor by the reaction force from the reduction gear via the projected portion of the side wall of the motor containing portion and the elastic member can firmly be restrained within predetermined ranges and a failure in operation and noise or the like by bending of the drive shaft of the motor and displacement of the motor can firmly be prevented.

According to the invention of Aspect 4, by respectively forming the projected portions at vicinities of the respective corner portions of the two side walls of the motor containing portion opposed to each other, bending of the drive shaft of the motor and displacement of the motor by the reaction from the reduction gear can firmly be absorbed and the actuator apparatus with high accuracy can be provided at low cost.

According to the invention of Aspect 5, by respectively forming the projected portions at the two side walls and the bottom wall of the motor containing portion and floatably supporting the motor surrounded by the elastic member in the cylindrical shape between the respective projected portions in the motor containing portion, bending (deformation) of the drive shaft of the motor and displacement of the motor by the reaction force from the reduction gear via the respective projected portions of the two side walls and the bottom wall of the motor containing portion and the elastic member can firmly be restrained within predetermined ranges and a failure in operation and noise or the like by bending of the drive shaft of the motor and displacement of the motor can firmly be prevented from being brought about.

According to the invention of Aspect 6, by respectively forming at least the pair of projected portions extended in parallel with the bottom wall of the motor containing portion and respectively forming at least the pair of projected portions extended in parallel to intersect with at least the pair of projected portions at the bottom portion of the elastic member in the cylindrical shape, by at least the pair of projected portions of the bottom wall of the motor containing portion and at least the pair of projected portions of the bottom portion of the elastic member in the cylindrical shape intersected with each other, bending of the drive shaft of the motor and displacement of the motor by the reaction force from the reduction gear can further firmly be absorbed and the actuator apparatus with high accuracy can be provided at low cost.

According to the invention of Aspect 7, by respectively forming the harness pinching portions at the two side portions of the elastic member in the cylindrical shape, the respective harnesses soldering the core lines to the pair of terminals attached to the motor can firmly be held by being positioned by the respective harness pinching portions of the two side portions of the elastic member and load applied on the respective harnesses can firmly be prevented from being transmitted to the soldered portions.

According to the invention of Aspect 8, by forming the terminal pressing portion at the upper portion of the elastic member in the cylindrical shape, a terminal inserted into the terminal connecting portion of the motor can firmly be pressed by the terminal holding portion of the upper portion of the elastic member and the terminal can firmly be prevented from being drawn.

According to the invention of Aspect 9, by forming the elastic member in the cylindrical shape by the thermoplastic elastomer species resin material, durability of the elastic member in the cylindrical shape can further be promoted.

### BRIEF DESCRIPTION OF THE DRAWINGS

FIG. 1 is a disassembled perspective view of steering locking apparatus of Embodiments 1 through 3 of the invention.

FIG. 2 is a plane view of the steering locking apparatus.

FIG. 3 is a bottom view of the steering locking apparatus.

FIG. 4 is a perspective view viewing the steering locking apparatus from a bottom face side.

FIG. 5 is a rear view of the steering locking apparatus.

FIG. 6 is a plane view of inside of a case of the steering locking apparatus.

FIG. 7 is a sectional view taken along a line X-X in FIG. 2.

FIG. 8 is a side view of a motor used in the steering locking apparatus.

FIG. 9 is a plane view of the motor.

FIG. 10A is a rear view of an elastic member in a cylindrical shape mounted to the motor, FIG. 10B is a side view of the elastic member, and FIG. 10C is a plane view of the elastic member.

FIG. 11A is an enlarged sectional view showing a terminal connecting portion of the motor, FIG. 11B is an enlarged sectional view showing a state of connecting a terminal to the terminal connecting portion, and FIG. 11C is a partial plane view of the motor in a state of connecting the terminal.

FIG. 12 is a sectional view taken along a line Y-Y in FIG. 2.

FIG. 13 is a sectional enlarging Z portion in FIG. 12.

FIG. 14A is an explanatory view showing a relationship among an output shaft, a stopper member, a damper and a cover used in the steering locking apparatus, and FIG. 14B is a sectional view taken along a line P-P of FIG. 14A.

FIG. 15A is a sectional view of a front end portion of the output shaft, and FIG. 15B is a side view of the front end portion of the output shaft.

FIG. 16A is a plane view of the stopper member, and FIG. 16B is a sectional view taken along a line Q-Q in FIG. 16A.

FIG. 17A is a plane view of the damper, and FIG. 17B is a sectional view of the damper.

FIG. 18A is a bottom view of an essential portion of the cover, and FIG. 18B is a sectional view taken along a line R-R in FIG. 18A.

FIG. 19A is a side view of a lower end portion of the output shaft, and FIG. 19B is a bottom view of the lower end portion of the output shaft.

FIG. 20A is an explanatory view showing a state of rotating the output shaft by a predetermined angle, and FIG. 20B is a explanatory view showing a state immediately before operating one of limit switches ON in the state.

FIG. 21A is an explanatory view showing a state before a projected portion of the output shaft impinges on a locking projected portion of the stopper member, and FIG. 21B is an explanatory view showing an ON state of one of the limit switches in the state.

FIG. 22A is an explanatory view showing a state of pressing the locking projected portion of the stopper member by the projected portion of the output shaft, and FIG. 22B is an explanatory view showing a state of operating one of the limit switches in the state.

FIG. 23A is an explanatory view showing a state of pressing a thick-walled portion of the damper between the stopper member and a stopper of the cover by rotating the stopper member, and FIG. 23B is an explanatory view showing a state of operating one of the limit switches in the state.

FIG. 24A is an explanatory view showing a state of bending the thick-walled portion of the damper between the stopper of the stopper member and the stopper of the cover, and FIG. 24B is an explanatory view showing a state of operating one of the limit switches in the state.

FIG. 25 is a plane view of inside of an actuator apparatus used in a steering locking apparatus of a background art.

FIG. 26 is a plane view showing a support portion of a motor of the actuator apparatus of the background art.

### DETAILED DESCRIPTION OF THE PREFRRED EMBODIMENTS

Embodiments 1 through 3 will be explained in reference to the drawings as follows.

### Embodiment 1

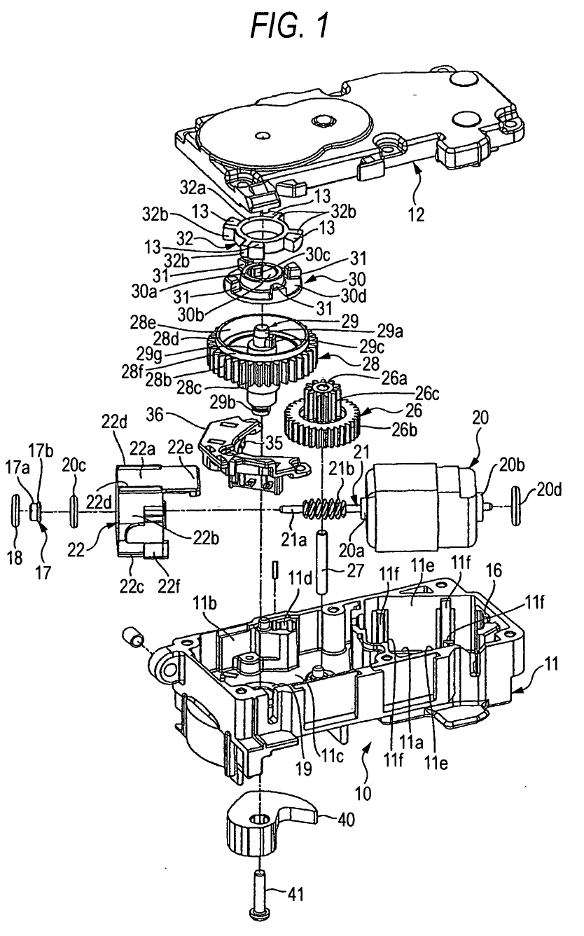

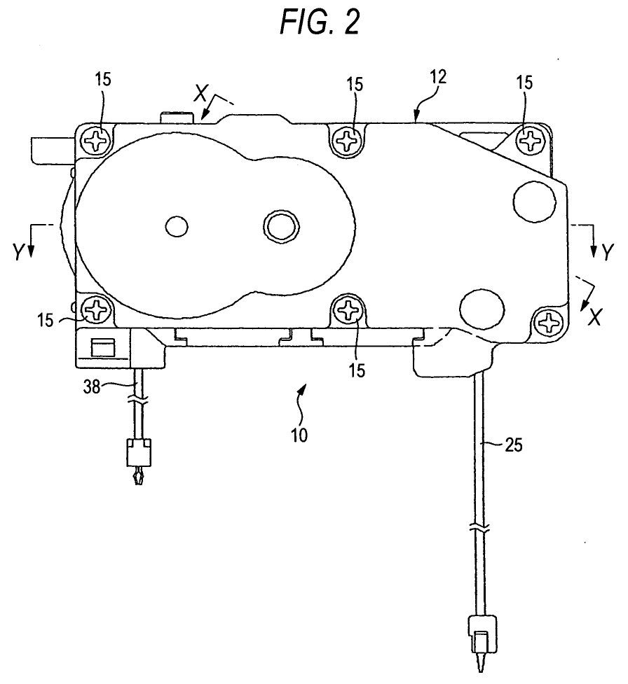

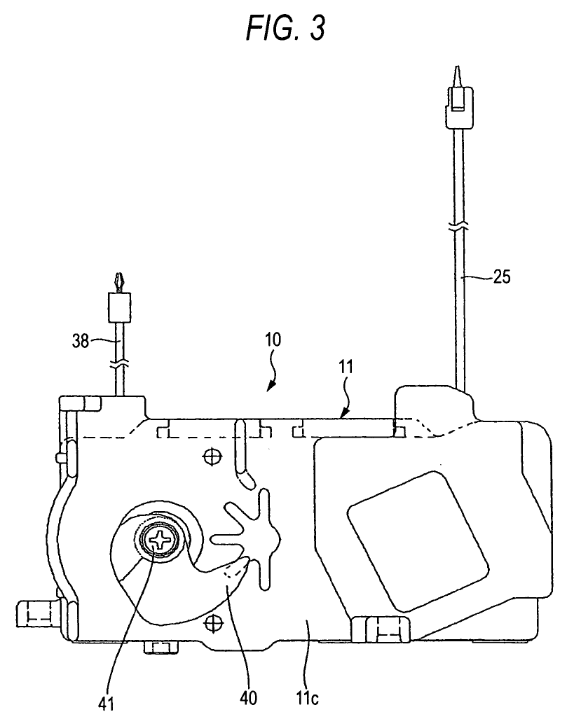

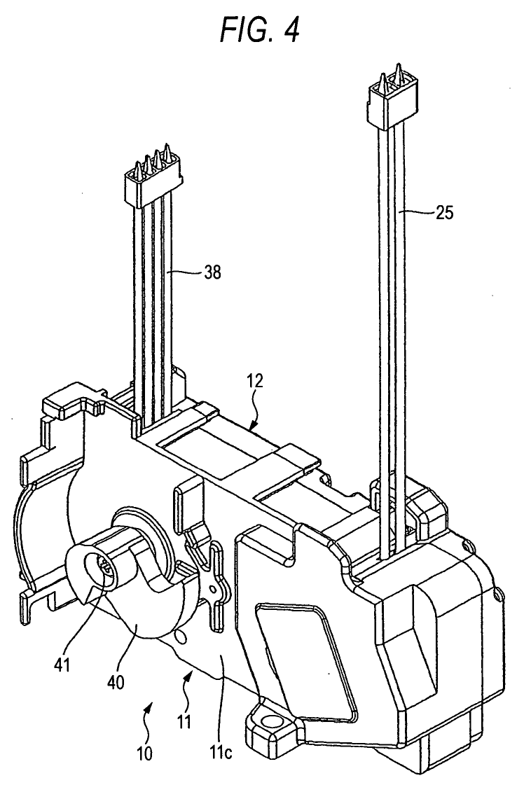

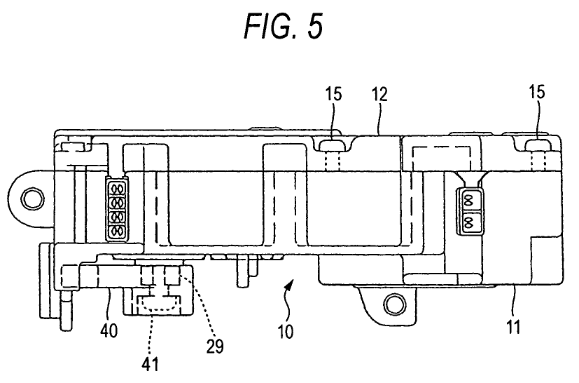

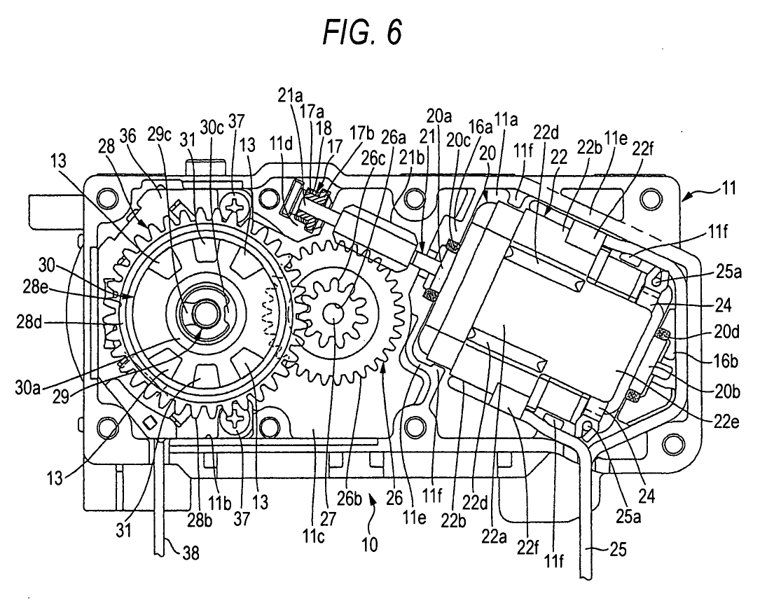

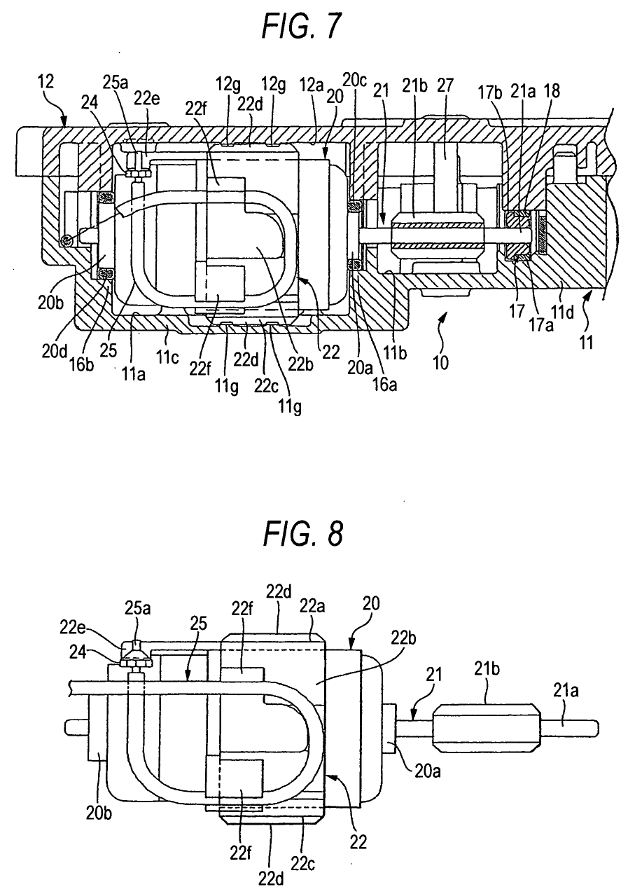

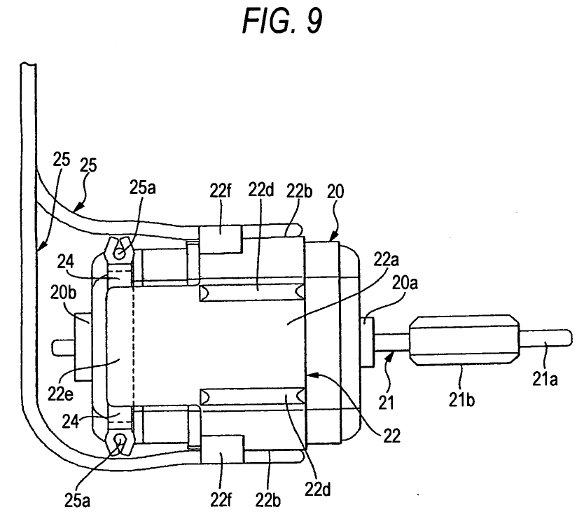

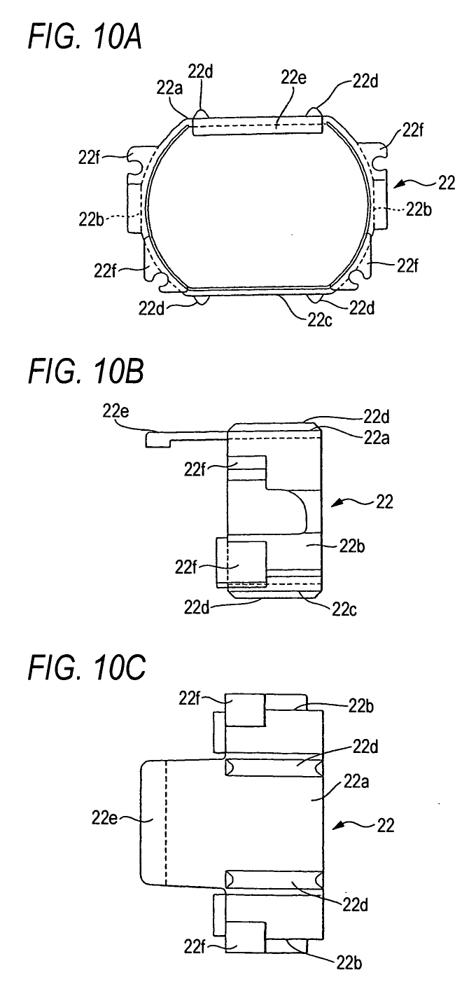

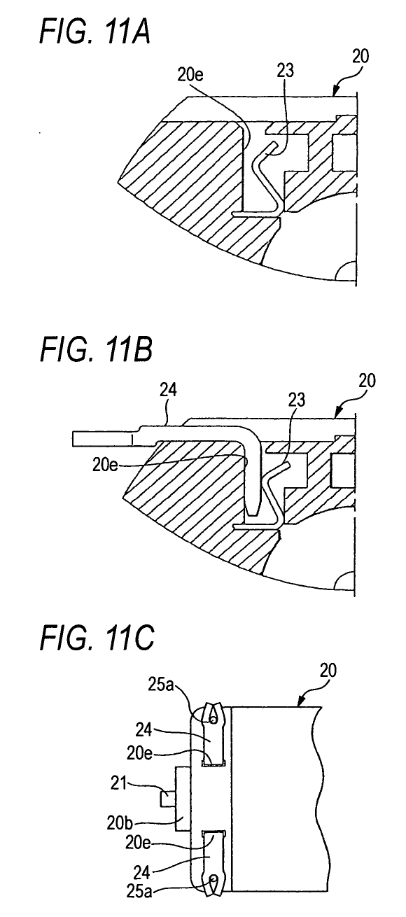

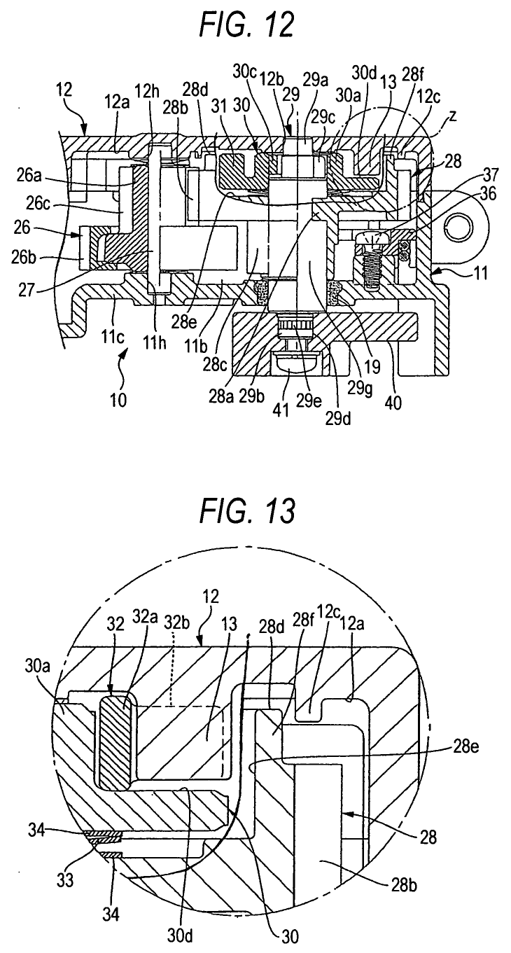

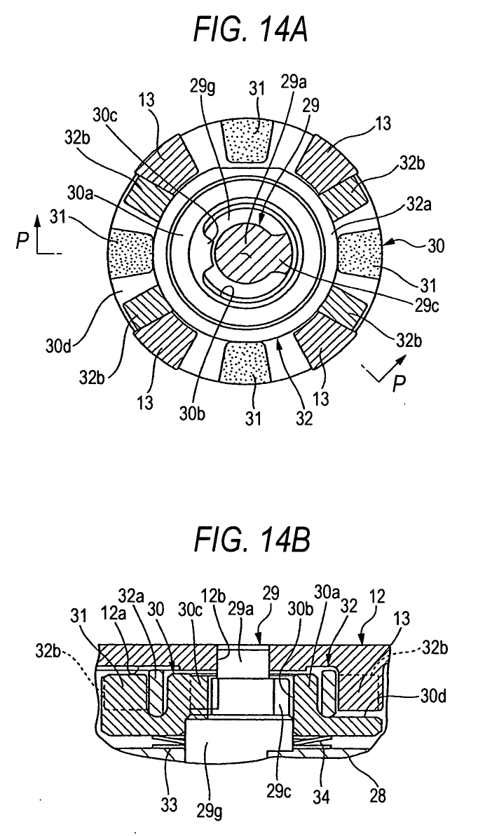

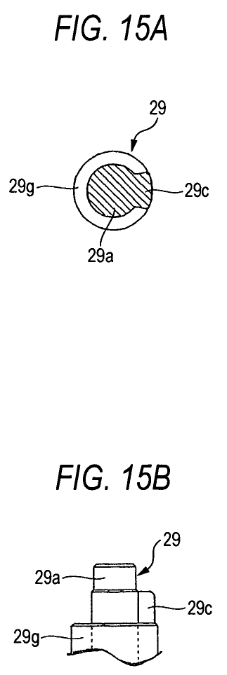

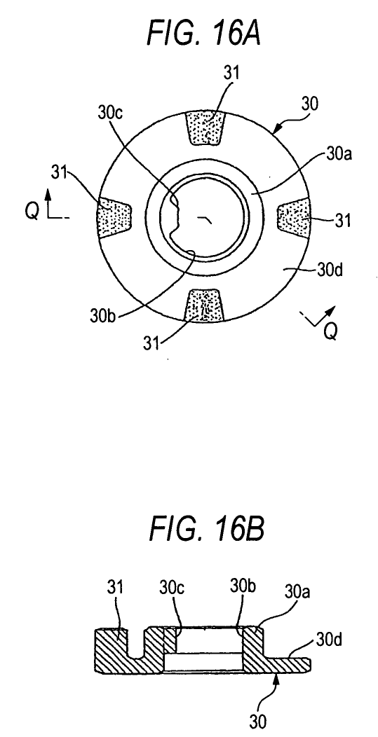

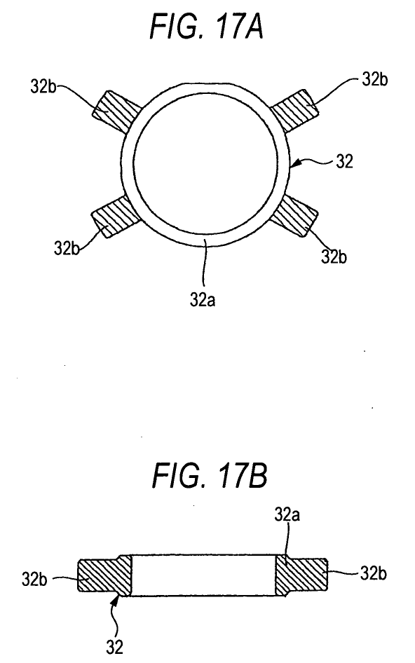

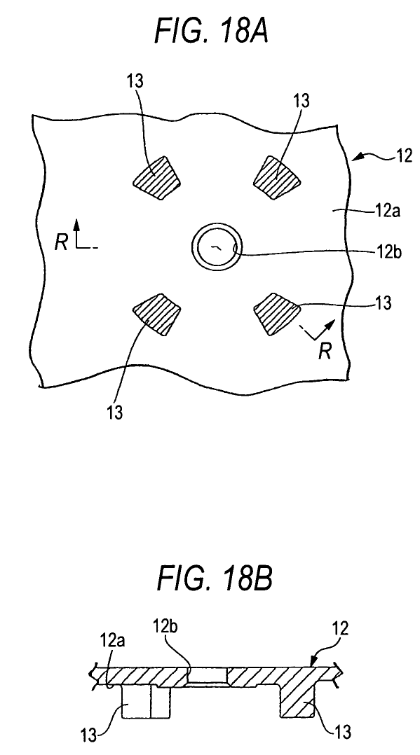

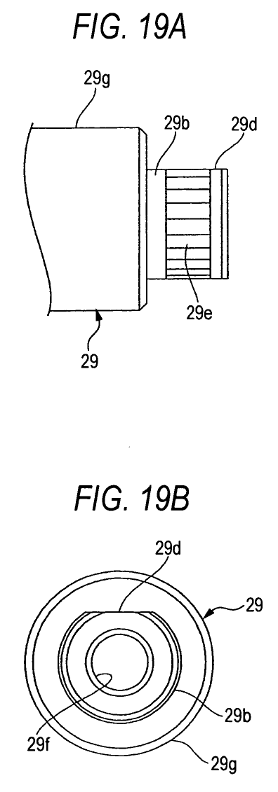

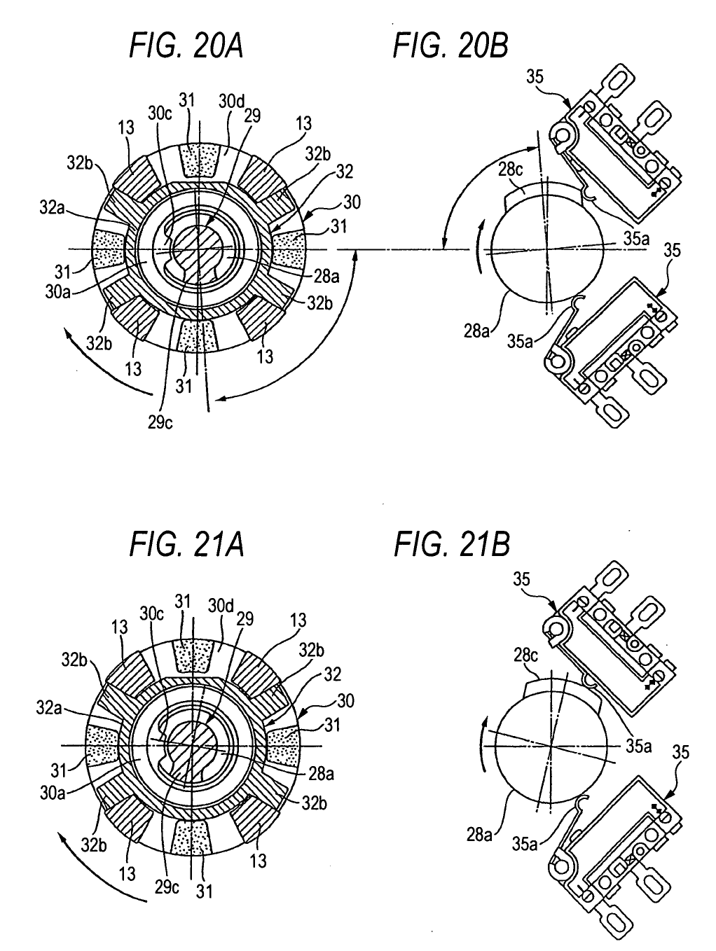

FIG. 1 is disassembled perspective view of a steering locking apparatus of Embodiment 1 according to the invention, FIG. 2 is a plane view of the apparatus, FIG. 3 is a bottom view of the apparatus, FIG. 4 is a perspective view viewing the apparatus from a bottom face side, FIG. 5 is a rear view of the apparatus, FIG. 6 is a plane view of inside of a case of the apparatus, FIG. 7 is a sectional view taken along a line X-X of FIG. 2, FIG. 8 is a side view of a motor used in the apparatus, FIG. 9 is a plane view of the motor, FIG. 10A is a rear view of an elastic member in a cylindrical shape mounted to the motor, FIG. 10B is a side view of the elastic member, FIG. 10C is a plane view of the elastic member, FIG. 11A is an enlarged sectional view showing a terminal connecting portion of the motor, FIG. 11B is an enlarged sectional view showing a state of connecting a terminal to the terminal connecting portion, FIG. 11C is a partial plane view of the motor in a state of connecting the terminal, FIG. 12 is a sectional view taken along a line Y-Y of FIG. 2, FIG. 13 is a sectional enlarging Z portion in FIG. 12, FIG. 14A is an explanatory view showing a relationship among an output shaft, a stopper member, a damper and a cover, FIG. 14B is a sectional view taken along a line P-P of FIG. 14A, FIG. 15A is a sectional view of a front end portion of the output shaft, FIG. 5B is a side view of the front end portion of the output shaft, FIG. 16A is a plane view of the stopper member, FIG. 16B is a sectional view taken along a line Q-Q of FIG. 16A, FIG. 17A is a plane view of the damper, FIG. 17B is a sectional view of the damper, FIG. 18A is a bottom view of an essential portion of the cover, FIG. 18B is a sectional view taken along a line R-R of FIG. 18A, FIG. 19A is a side view of a lower end portion of the output shaft, FIG. 19B is a bottom view of the lower end portion of the output shaft, and FIG. 20 through FIG. 24 are explanatory views for successively explaining a relationship between a state of rotating the output shaft and a state of operating a limit switch.

As shown by FIG. 1 through FIG. 6, a steering locking apparatus (actuator apparatus) 10 is provided with a case 11 made of a synthetic resin in a box-like shape having a motor containing portion 11a and a gear containing portion 11b communicated with the motor containing portion 11a, and a cover 12 made of a synthetic resin fastened to fix by a screw 15 to cover the motor containing portion 11a and the gear containing portion 11b of the case 11. A motor 20 is contained in the motor containing portion 11a of the case 11, and a front end 21a of an armature shaft (drive shaft) 21 is rotatably supported by a bearing 17 held by a bearing holding portion 17a of the gear containing portion 11b. A small diameter portion 17a of the bearing 17 is fitted with an O ring (vibration isolating member) 18 made of rubber. The front end 21a of the armature shaft 21 of the motor 20 is floatably supported by the bearing holding portion 11d of the gear containing portion 11b by the bearing 17 and the O ring 18 made of rubber. Further, a worm 21b is formed at a front end side of the armature shaft 21, and the worm 21b is brought into the gear containing portion 11b. Further, when a current is supplied to an armature coil of an armature, not illustrated, attached to the armature shaft 21, the armature is regularly rotated or reversely rotated, and when the current supplied to the armature coil is cut, an electromagnetic braking circuit is formed and an electromagnetic braking current is made to flow to the armature coil.

As sown by FIGS. 1 and 6, a pair of projected portions 11f, 11f extended in parallel in an up and down direction are respectively integrally formed to project with both sides of side walls 11e, 11e opposed to each other of the motor containing portion 11a of the case 11 (vicinities of respective corner portions). Further, as shown by FIG. 7, a bottom wall 11c at inside of the motor containing portion 11e is respectively integrally projected to form with a pair of projected portions 11g, 11g extended in parallel in a width direction. The motor 20 is floatably supported on the respective projected portions 11f, 11g of the motor containing portion 11a via an elastic member 22 mounted to the motor 20. Further, O rings 20c, 20d made of rubber are fitted to forward and rearward bearing portions 20a, 20b of the motor 20, and the bearing portions 20a, 20b are respectively held by bearing holding portions 16a, 16b of the case 11 via the respective O rings 20c, 20d, and the motor 20 is floatably supported by forward and rearward sides of the motor containing portion 11a. That is, the motor 20 is disposed in the motor containing portion 11a and is floatably supported by the case 11 by the elastic member 22 and the respective O rings 20c, 20d.

As shown by FIG. 6 through FIG. 10, the elastic member 22 is formed in a cylindrical shape by, for example, a thermoplastic elastomer species resin material. That is, the elastic member 22 is formed in the cylindrical shape by an upper wall portion (upper portion) 22a, two side wall portions 22b, 22b and a bottom wall portion (bottom portion) 22c. Outer faces of the upper wall portion 22a and the bottom wall portion 22c of the elastic member 22 are respectively integrally projected to form with a pair of projected portions 22a, 22d extended in parallel in a forward and rearward direction. As shown by FIG. 7, the respective pairs of projected portions 22d, 22d are respectively intersected with a pair of projected portions 11g, 11g of the bottom wall 11c of the motor containing portion 11a and a pair of projected portions 12g, 12g integrally projected to form with an inner face 12a of the cover 12. Thereby, the motor 20 is supported between the pair of projected portions 11g, 11g of the bottom wall 11c of the motor containing portion 11a and the pair of projected portions 12g, 12g of the inner face 12a of the cover 12 via the pair of projected portions 22d, 22d of the upper wall portion 22a and the pair of projected portion 22d, 22d of the bottom wall portion 22c of the elastic member 22.

Further, a terminal holding portion 22e is extended from a rear side of the upper wall portion 22a of the elastic member 22. As shown by FIGS. 9 and 11, the terminal holding portion 22e is for holding a terminal 24 in an L-like shape inserted to be brought into contact with a terminal connecting piece 23 in a shape of a metal plate and substantially in a Z-like shape arranged in a hole portion 20e of the motor 20. A core wire 25a of a harness 25 is pinched by substantially a V-like portion of one end of the terminal 24 to be soldered. Further, as shown by FIG. 6 through FIG. 10, upper and lower portions of the two side wall portions 22b, 22b of the elastic member 22 are respectively integrally projected to form with a pair of harness pinching portions 22f, 22f holding the harness 25.

As shown by FIGS. 1, 6, 7 and 12, the gear containing portion 11b of the case 11 is respectively rotatably contained with a reduction gear 26 made of a synthetic resin driven to rotate by the armature shaft 21 of the motor 20 and an output gear 28 made of a synthetic resin driven to rotate via the reduction gear 26. The reduction gear 26 includes a large diameter gear portion 26b brought in mesh with the worm 21b of the armature shaft 21 of the motor 20 and a small diameter gear portion 26c brought in mesh with the output gear 28. Further, a round hole 26a is formed at center of the reduction gear 26 and the support shaft 27 is penetrated into the round hole 26. As shown by FIG. 12, upper and lower ends of the support shaft 27 are fitted to a recess portion 11h of the bottom wall 11c of the case 11 and a recess portion 12h of the inner face 12a of the cover 12 and the reduction gear 26 is rotatably supported via the support shaft 27.

As shown by FIGS. 1, 6 and 12, inside of a gear main body portion 28a in a cylindrical shape of an output gear 28 is integrally formed with an output shaft 29 in a cylindrical shape made of a metal by insert molding or the like. A lower end portion of the output shaft 29 having a small diameter is rotatably supported by a bearing 19 fitted to the bottom wall 11c of the case 11 and an upper end portion 19a having a small diameter of the output shaft 29 is rotatably supported by a bearing portion 12b formed at the cover 12. Thereby, both of the output gear 28 and the output shaft 29 are rotated. Further, a lower end of the gear main body portion 28a of the output gear 28 is integrally projected to form with a cam portion 28c. Inside of the gear containing portion 11b of the case 11 opposed to the cam portion 28c is attached with a pair of limit switches (switching means) 35, 35 operated to ON or OFF by the cam portion 28c via a switch holder 36 made of synthetic resin and a screw 37 or the like. Further, as shown by FIGS. 2, 3, 4 and 6, the respective limit switches 35 are respectively connected with a pair of harnesses 38, 38.

Further, as shown by FIGS. 1, 6, 12 and 14, an upper face 28d of the output gear 28 is formed with a containing recess portion 28e in a shape of a circular ring for rotatably containing a stopper member 30 comprising a sintered metal. A lower side of an upper end portion 29a having a small diameter of the output shaft 29a facing inside of the containing recess portion 28e is integrally projected to form with a projected portion 29c. Further, as shown by FIG. 16, the stopper member 30 is formed substantially in a circular plate shape having a cylindrical portion 30a at a center thereof. According to the stopper member 30, an inner peripheral face 30b of the cylindrical portion 30a is fitted to an intershaft portion 29g having a large diameter of the output shaft 29 and the stopper member 30 is rotatably attached to the output shaft 29. Further, the inner peripheral face of the cylindrical portion 30a is integrally projected to form with a locking projected portion 30c locked by and separated from the projected portion 29c of the output shaft 29. Further, an upper face 30d of the stopper member 30 is respectively integrally with projected to form with four of stoppers 31 brought into contact to be locked by respective stoppers 13 of the cover 12, mentioned later, at equal intervals.

As shown by FIG. 12 through FIG. 14 and FIG. 18, the inner face 12a of the cover 12 is integrally projected to form with four of the stoppers 13 for restricting a range of rotating the output gear 28 such that the output gear 28 is rotated by a previously determined angle at predetermined intervals on the same circumference. Further, a damper 32 made of rubber is interposed between the respective stoppers 13 of the inner face 12a of the cover 12 (between the respective stoppers 31 of the stopper member 30 and the respective stoppers 13 of the inner face 12a of the cover 12). As shown by FIG. 17, the damper 32 includes a damper main body 32a in a shape of a circular ring and the damper main body 32a in the shape of the circular ring is integrally projected to form with four of thick-walled portions 32b respectively arranged between the respective stoppers 31 of the stopper main body 30 and the respective stoppers 13 of the inner face 12a of the cover 12 at predetermined intervals.

That is, as shown by FIG. 14, before rotating the output gear 28 and the output shaft 29, the respective upper and lower pairs of the thick-walled portions 32b, 32b of the damper 32 disposed on the left and on the right opposed to the projected portions 29c of the output shaft 29 and the locking projected portions 30c of the stopper member 30 are previously brought into contact with faces of the respective upper and lower pair of stoppers 13, 13 opposed to each other disposed on the left and on the right of the inner face 12a. Thereby, the respective stoppers 13 of the inner face 12a of the cover 12 and the thick-walled portions 32b of the damper 32 mounted between the respective stoppers 13 are contained to be separated from each other substantially at equal intervals between the respective stoppers 31 of the stopper member 30 contained in the containing recess portion 28e of the output gear 28. Further, a curve washer (bending washer) 33 and a pair of flat washers 34, 34 for pinching the curve washer 33 are interposed between the bottom face of the containing recess portion 28e and the bottom portion of the stopper member 30. The stopper member 30 is always urged to the side of the inner face 12a of the cover 12 by an elastic force of the curve washer 33.

Further, as shown by FIGS. 12 and 13, outer sides of the respective stoppers 13 of the inner face 12a of the cover 12 are integrally projected to form with projected portions 12c for labyrinth extended to surround a peripheral wall 28f forming the containing recess portion 28e of the output gear 28. A labyrinth structure is formed by the projected portions 12c for labyrinth of the cover and the peripheral walls 28f of the output gear 28.

Further, as shown by FIGS. 12 and 19, a lower end portion 29b of the output shaft 29 exposed to outer side from the bottom wall 11c of the case 11 is respectively formed with a D-cut portion 29d for preventing rotation and a rattling preventing serration portion 29e and formed with a screw hole 29f at a center thereof. Further, the lower end portion 29b of the output shaft 29 is fastened to fix with an output cam (output member) 40 used for locking and unlocking steering shaft, not illustrated, via a screw 41.

According to the steering locking apparatus 10 of Embodiment 1 described above, when a current is supplied to an armature coil, not illustrated, of the motor 20, the worm 21b of the armature shaft 21 is rotated and the output gear 28 is rotated via the reduction gear 26. The output shaft 29 is rotated along with rotation of the output gear 28.

When the output gear 28 and the output shaft 29 are rotated by a predetermined angle in an arrow mark direction shown in FIG. 20A from a state in which the respective stoppers 31 of the stopper member 30 contained in the containing recess portion 28e of the output gear 28 are separated from the respective stoppers 13 of the cover 12 as shown by FIGS. 14A and 14B, as shown by FIG. 20B, an operating lever portion 35a of one of the limit switches 35 in an OFF state (OFF) arranged at a corner portion in the gear containing portion 11b of the case 11 is pressed by the cam portion 28c integrally projected to form with the gear main body portion 28a of the output gear 28 to bring the limit switch 35 into an ON state (ON).

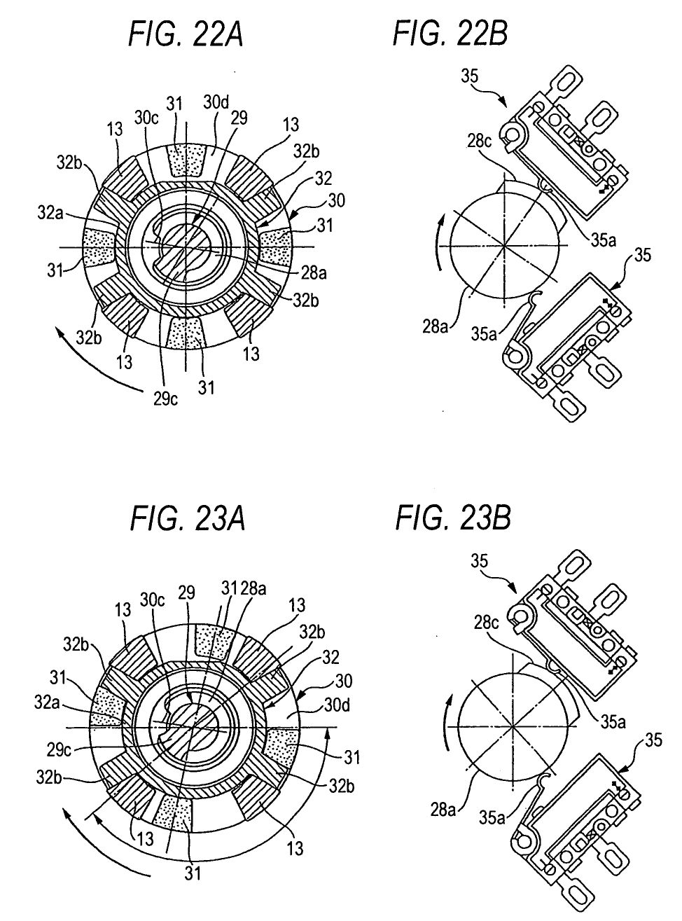

By making the limit switch 350N, a position detecting signal is outputted to the motor 20 to make electricity conduction OFF and cuts a current supplied to the armature coil, and after making the limit switch 350N, as shown by FIG. 21A, the output gear 28 and the output shaft 29 are still rotated by delay and inertia. At this occasion, for example, when supply voltage is high or an atmosphere temperature is high, overrunning by delay and inertia is increased, even after making the limit switch 350N, as shown by FIG. 22A, the output gear 28 and the output shaft 29 are further rotated in the arrow mark direction.

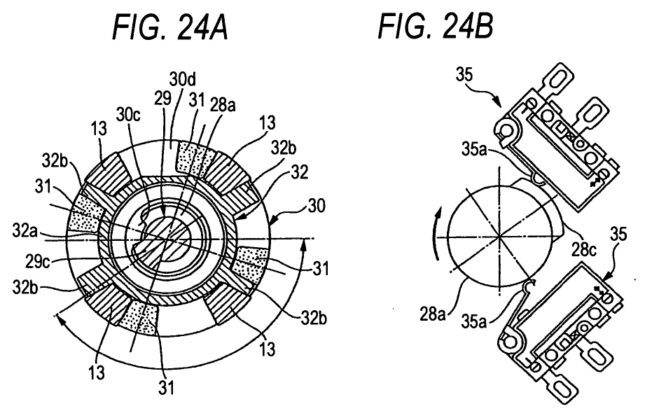

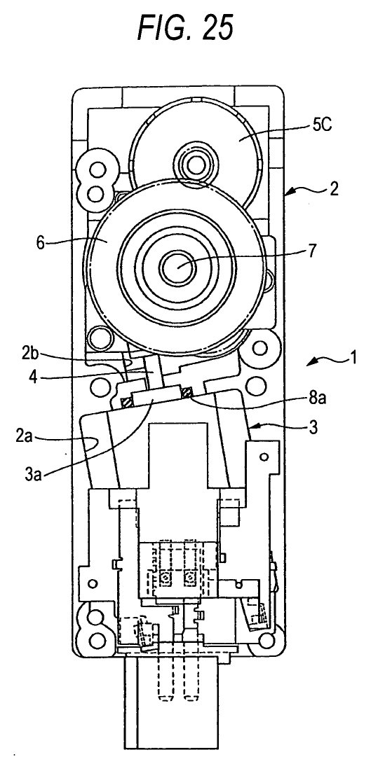

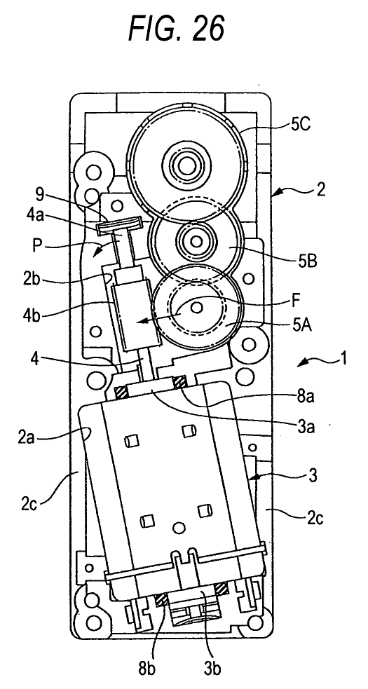

By rotating the output gear 28 and the output shaft 29, as shown by FIG. 22A, the projected portion 29c of the output shaft 29 presses the locking projected portion 30c of the stopper member 30 contained in the containing recess portion 28e of the output gear 28. Thereby, as shown by FIG. 23A, the stopper member 30 in the containing recess portion 28e of the output gear 28 is rotated in the arrow mark direction, and two of the stoppers 31 of the stopper member 30 opposed to each other respectively press two of the thick-walled portions 32b opposed to each other of the damper 32 made of rubber respectively mounted between two of the stoppers opposed to each other of the cover 12. By pressing the thick-walled portions 32b, as shown by FIG. 24A, the two thick-walled portions 32b opposed to each other of the damper 32 made of rubber are bent and other of the two stoppers 31 opposed to each other of the stopper member are respectively brought into contact to be locked by other of the two stoppers 13 opposed to each other of the cover 12. At the time point, rotation of the output gear 28 and the output shaft 29 is stopped. A position of stopping the output gear 28 is a position of maintaining the ON state of the limit switch by the cam portion 28c.

In this way, by bringing the two stoppers 31 opposed to each other of the stopper member 30 contained in the containing recess portion 28e of the output gear 28 into contact with the two stoppers 13 opposed to each other of the cover 12 respectively via the two thick-walled portions 32b opposed to each other of the damper 32 made of rubber, bending the two-thick walled portions 32b opposed to each other by a predetermined amount and respectively bringing other of the two stoppers 31 opposed to each other of the stopper member 30 into contact with other two stoppers 31 opposed to each other of the cover 12 to lock, the output gear 28 can always be stopped after firmly rotating the output gear 28 by a constant range. At this occasion, impact (load) applied when the respective stoppers 13 of the cover 12 and the respective stoppers 31 of the stopper member 30 are brought into contact to be locked can firmly be absorbed by compressing the pair of thick-walled portions 32b, 32b of the damper 32 made of rubber mounted to the respective stoppers 13 of the cover 12. Thereby, deformation of bending or floating up of the cover 12 can firmly be restrained and destruction of the respective stoppers 31 of the stopper member 30 and the respective stoppers 13 of the cover 12 can firmly be prevented.

Further, as shown by FIG. 6, by floatably supporting the motor 20 between the two side walls 11e, 11e of the motor containing portion 11a of the case 11 via the elastic member 22 and floatably supporting the front end 21a of the armature shaft 21 of the motor 20 in the bearing holding portion 11d of the gear containing portion 11b via the O ring 18 made of rubber fitted to the small diameter portion 17a of the bearing 17, bending (deformation) of the armature shaft 21 and displacement of the motor 20 in the motor containing portion 11a by the reaction force F from the reduction gear 26 brought in mesh with the worm 21b of the armature shaft 21 of the motor 20 via the elastic member 22 and the O ring 18 made of rubber can firmly be restrained within predetermined ranges, a failure in operation by bending the armature shaft 21 of the motor 20 or displacing the motor 20 or noise or the like can firmly be prevented from being brought about and noise can firmly be prevented from being transmitted to the case 11.

That is, by the floating support structure of the motor 20 by the elastic member 22 and the floating support structure of the armature shaft 21 by the O ring 18 made of rubber, bending of the armature shaft 21 of the motor 20 and displacement of the motor 20 in the motor containing portion 1a by the reaction force F form the reduction gear 26 can firmly be restrained within predetermined ranges. Further, before exceeding a limit value of a rate of bringing the worm 21b of the armature shaft 21 and the reduction gear 26 in mesh with each other, the bending and the displacement can firmly be absorbed by the respective floating support structures and there can be provided the steering locking apparatus 10 with high accuracy capable of always ensuring the rate of bringing the worm 21b of the armature shaft 21 and the reduction gear 26 in mesh with each other in an excellent state at low cost.

Particularly, in normal operation, when the armature shaft 21 of the motor 20 is bent by the reaction force F from the reduction gear 26, deformation of the armature shaft 21 can firmly be absorbed by the O ring 18 made of rubber fitted to the small diameter portion 17a of the bearing 17. Further, when the armature shaft 21 is bent to some degree, a large diameter portion 17b of the bearing 17 is brought into contact with one side wall of the bearing holding portion 11d in a recess shape of the gear containing portion 11b and bending of the armature shaft 21 more than necessary can firmly be prevented. Thereby, vibration or noise or the like from the front end 21a of the armature shaft 21 and the bearing 17 can firmly be restrained and still sound formation of the total can be achieved.

Further, by projecting to form the cam portion 28c integrally with the gear main body portion 28a of the output gear 28 containing the stopper member 30 for stopping firmly rotation of the output gear 28 and the output shaft 29 by the respective stoppers 31, a phenomenon that the cam portion 28c rides over the operating lever portion 35a of the limit switch 35 can firmly be prevented and the limit switch 35 can firmly be operated ON or OFF by the cam portion 28c.

Further, although according to Embodiment 1, the elastic member is constituted by the thermoplastic elastomer species resin material, a member other than rubber material or the like may be used. Further, although the O ring made of rubber is used as the vibration isolating member, the vibration isolating member is not limited thereto. Further, although there is shown an example of mounting the dampers made of rubber to the four stoppers of the cover and respectively pressing thick-walled portions opposed to each other of the dampers by two of the stoppers opposed to each other in the four stoppers of the stopper member, Embodiment 1 is naturally applicable to an example in which the four stoppers of the stopper member are brought into direct contact to be locked by the four stoppers of the cover without mounting the dampers.

### Embodiment 2

As shown by FIG. 6, by respectively integrally projecting to form the pair of projected portions 11f, 11f extended in parallel in the up and down direction at both sides of the two side walls 11e, 11e opposed to each other of the motor containing portion 11a of the case 11 (vicinities of respective corner portions) and floatably supporting the motor 20 between the two sie walls 11e, 11e of the motor containing portion 11a via the cylindrical elastic member 22, bending (deformation) of the armature shaft 21 and displacement in the motor containing portion 11a of the motor 20 by the reaction force F from the reduction gear 26 brought in mesh with the worm 21b of the armature shaft 21 of the motor 20 via the respective projected portions 11f, 11f of the two side walls 11e, 11e of the motor containing portion 11a and the elastic member 22 can firmly be restrained within predetermined ranges, and a failure in operation by the bending of the armature shaft 21 of the motor 20 and displacement of the motor 20 or noise or the like can firmly be prevented from being brought about.

That is, by the floating support structure of the motor 20 by the respective projected portions 11f, 11f of the two side walls 11e, 11e of the motor containing portion 11a and the elastic member 22 mounted to the motor 20, bending of the armature shaft 21 of the motor 20 and displacement of the motor 20 in the motor containing portion 11a by the reaction force F from the reduction gear 26 can firmly be restrained within predetermined ranges. Further, before exceeding the limit value of the rate of bringing the worm 21b of the armature shaft 21 and the reduction gear 26 in mesh with each other, the bending and the displacement can further firmly be absorbed by the floating support structure, and the steering locking apparatus 10 with high accuracy capable of ensuring the rate of bringing the worm 21e of the armature shaft 21 and the reduction gear 26 in mesh with each other always in an excellent state can be provided at low cost.

### Embodiment 3

As shown by FIG. 6 through FIG. 10, the elastic member 22 is formed in the cylindrical shape by, for example, the thermoplastic elastomer species resin material. That is, the elastic member 22 is formed in the cylindrical shape by the upper wall portion (upper portion) 22a, the two side wall portions (two side portions) 22b, 22b and the bottom wall portion (bottom portion) 22c. The outer shapes of the upper wall portion 22a and the bottom wall portion 22c of the elastic member 22 are respectively integrally projected to form with the pairs of projected portions 22d, 22d extended in parallel in the forward and rearward direction. As shown by FIG. 7, the respective pairs of projected portions 22d, 22d are respectively intersected with the pair of projected portions 11g, 11g of the bottom wall 11c of the motor containing portion 11a and the pair of projected portions 12g, 12g integrally projected to form with the inner face 12a of the cover 12. Thereby, the motor 20 is floatably supported between the pair of projected portions 11g, 11g of the bottom wall 11c of the motor containing portion 11a and the pair of projected portions 12g, 12g of the inner face 12a of the cover 12 via the pair of projected portions 22d, 22d of the upper wall portion 12a and the pair of projected portions 22d, 22d of the bottom wall portion 22c of the elastic member 22.

Further, the terminal pressing portion 22e is extended from the rear side of the upper wall portion 22a of the elastic member 22. As shown by FIGS. 9 and 11, the terminal pressing portion 22e is for pressing the terminal 24 in the L-like shape inserted to be brought into contact with the terminal connecting piece 23 in the shape of the metal plate and substantially in the Z-like shape arranged in the hole portion 22e of the motor 20. The core wire 25a of the harness 25 is pinched by and soldered at a substantially V-like portion of one end of the terminal 24 (a soldered portion is designated by notation H in FIG. 8). Further, as shown by FIG. 6 through FIG. 10, the pair of harness pinching portions 22f, 22f for holding the harness 25 are respectively integrally projected to form with the upper and the lower portions of the two side wall portions 22b, 22b of the elastic member 22.

Further, as shown by FIGS. 6 and 7, by respectively integrally projecting to form the pairs of projected portions 22d, 22d extended in parallel in the forward and rearward direction at the outer faces of the upper wall portion 22a and the bottom wall portion 22c of the elastic member 22, forming the respective pair of projected portions 22d, 22d to respectively intersect with the pair of projected portions 11g, 11g of the bottom wall 11c of the motor containing portion 11a and the pair of projected portions 12g, 12g integrally projected to form with the inner face 12a of the cover 12, and floatably supporting the motor 20 between the pair of projected portions 11g, 11g of the bottom wall 11c of the motor containing portion 11a and the pair of projected portions 12g, 12g of the inner face 12a of the cover 12 via the pair of projected portions 22d, 22d of the upper wall portion 22a and the pair of projected portions 22d, 22d of the bottom wall portion 22c of the elastic member 22, bending (deformation) of the armature shaft 21 and displacement of the motor 20 in the motor containing portion 11a by the reaction force F from the reduction gear 26 brought in mesh with the worm 21b of the armature shaft 21 of the motor 20 via the respective projected portions 11f, 11g of the two side walls 11e, 11e and the bottom wall 11c of the motor containing portion 11a, the respective projected portions 12g of the inner face 12a of the cover 12 and the respective projected portions 22d of the upper wall portion 22a and the bottom wall portion 22c of the elastic member 22 can firmly be restrained within the predetermined ranges, a failure in operation by bending of the armature shaft 21 of the motor 20 and displacement of the motor 20 and noise or the like can firmly be prevented from being brought about.

That is, by the floating support structure of the motor 20 by the respective projected portions 11f, 11g of the two side walls 11e, 11e and the bottom wall 11c of the motor containing portion 11a, the respective projected portions 12g of the inner face 12a of the cover 12 and the respective projected portions 22d of the upper wall portion 22a and the bottom wall portion 22c of the elastic member 22 mounted to the motor 20, bending of the armature shaft 21 of the motor 20 and displacement of the motor 20 in the motor containing portion 11a by the reaction force F from the reduction gear 26 can firmly be restrained within the predetermined ranges. Further, before exceeding the limit value of the rate of bringing the worm 21b of the armature shaft 21 and the reduction gear 26 into mesh with each other, the bending and the displacement can further firmly be absorbed by the floating support structure, and the rate of bringing the worm 21b of the armature shaft 21 and the reduction gear 26 in mesh with each other can be ensured in an excellent state. Thereby, the steering locking apparatus 10 with high accuracy can be provided at low cost.

Further, as shown by FIG. 7 through FIG. 11, by respectively forming the respective pair of upper and lower harness pinching portions 22f, 22f at the two side wall portions 22b, 22b of the cylindrical elastic member 22 for floatably supporting the motor 20, the respective harnesses (lead wires) 25 for soldering the core wires to the pair of terminals 24, 24 inserted into the pair of hole portions (terminal connecting portions) 20e, 20e of the motor 20 can firmly be held by being positioned in a bent state in substantially a C-like shape via the respective pair of upper and lower harness pinching portions 22f, 22f of the two side wall portions 22b, 22b of the elastic member 22, and load applied to the respective harnesses 25 from outside can firmly be prevented from being transmitted to the soldered portions H of the respective terminals 24 and the core wires 25a of the respective harnesses 25.

Further, by integrally forming the terminal holding portions 22e at the upper wall portion 22a of the cylindrical elastic member 22, the respective terminals 24 inserted into the pair of hole portions 22e, 22e of the motor 20 can firmly be pressed by the terminal pressing portions 22e of the upper wall portion 22a of the elastic member 22 and the respective terminals 24 can firmly be prevented from being drawn. In this way, the cylindrical elastic member 22 is made to serve as a structure of floatably supporting the motor 20, a structure of positioning to hold the harness 25 and a structure of holding the terminal 24. Further, by forming the cylindrical elastic member 22 by the thermoplastic elastomer species resin material, durability of the cylindrical elastic member 22 can further be promoted.

What is claimed is:

1. An actuator apparatus comprising:
a case having a cover for covering a motor containing portion and a gear containing portion,
a motor contained in the motor containing portion of the case,
an output gear rotatably contained in the gear containing portion of the case and driven to rotate by a drive shaft of the motor via a reduction gear,
an output shaft rotatably supported by the case and rotated along with the output gear, and
an output member attached to the output shaft, wherein
the motor is floatably supported in the motor containing portion via an elastic member,
a front end of the drive shaft of the motor is rotatably supported via a bearing held by a bearing holding portion of the gear containing portion, and
the bearing is floatably supported by the bearing holding portion of the gear containing portion via a vibration isolating member.

2. The actuator apparatus according to claim 1, wherein
the vibration isolating member is formed by an O ring made of rubber fitted to a small diameter portion of the bearing.

3. An actuator apparatus comprising:
a case having a cover for covering a motor containing portion and a gear containing portion,
a motor contained in the motor containing portion of the case,
an output gear rotatably contained in the gear containing portion of the case and driven to rotate by a drive shaft of the motor via a reduction gear,
an output shaft rotatably supported by the case and rotated along with the output gear, and
an output member attached to the output shaft, wherein
a projected portion is formed at at least a side wall of the motor containing portion, and
the motor is floatably supported in the motor containing portion via an elastic member.

4. The actuator apparatus according to claim 3, wherein
the projected portions are respectively formed at vicinities of respective corner portions of the two side walls of the motor containing portion opposed to each other.

5. An actuator apparatus comprising:
a case having a cover for covering a motor containing portion and a gear containing portion,
a motor contained in the motor containing portion of the case,
an output gear rotatably contained in the gear containing portion of the case and driven to rotate by a drive shaft of the motor via a reduction gear,
an output shaft rotatably supported by the case and rotated along with the output gear, and
an output member attached to the output shaft, wherein
projected portions are respectively formed at two side walls and a bottom wall of the motor containing portion, and
the motor surrounded by an elastic member in a cylindrical shape is floatably supported between the projected portions in the motor containing portion.

6. The actuator apparatus according to claim 5, wherein
at least a pair of the projected portions extended in parallel with the bottom wall of the motor containing portion are respectively formed and at least a pair of projected portions extended in parallel to intersect with at least the pair of projected portions are respectively formed at a bottom portion of the elastic member in the cylindrical shape.

7. The actuator apparatus according to claim 5, further comprising:
harness pinching portions respectively formed at two side portions of the elastic member in the cylindrical shape.

8. The actuator apparatus according to claim 5, further comprising:
a terminal holding portion formed at an upper portion of the elastic member in the cylindrical shape.

9. The actuator apparatus according to claim 5, wherein
the elastic member in the cylindrical shape is formed by a thermoplastic elastomer species resin material.
